(19) United States
(12) Patent Application Publication
(10) Pub. No.: US 2006/0116930 A1
(43) Pub. Date: Jun. 1, 2006

(54) Computer system and method for development and marketing of consumer products

(76) Inventor: Steven W. Goldstein, Delray Beach, FL (US)

Correspondence Address: PLEVY & HOWARD, P.C., P.O. BOX 226, FORT WASHINGTON, PA, 19034, US

(21) Appl. No.: 11/253,381

(22) Filed: Oct. 19, 2005

Related U.S. Application Data
(60) Provisional application No. 60/619,989, filed on Oct. 19, 2004.

(51) Int. Cl. G06Q 30/00

(52) U.S. Cl. 705/14

(57) ABSTRACT

A computer-implemented method for the design and/or marketing of one or more consumer products based on an identified Icon includes capturing and storing in memory preferences of the Icon in accordance with at least one systematic survey of at least some of the preferences; creating one or more of a design for at least one consumer product or for a space or scheme for marketing and promotion, the consumer product, space or scheme design incorporating the captured preferences; and storing the design in memory. The preferences may include aspects of a product or space and information regarding the background of the Icon. A method for at least one of the design and marketing of one or more consumer products includes creating a design for at least one of a consumer product and an environment for sales, promotion and/or demonstration of at least one consumer product, the design incorporating captured preferences of an Icon; and storing the design in memory. A method for marketing of a consumer product includes communicating to prospective customers incorporation of preferences of an Icon in at least one of the design and/or marketing of the consumer product; making the consumer product available for purchase. A determination may be made as to whether a person has Icon status by obtaining and storing in memory values of objective and subjective variables, entering the variables into a weighted formula, calculating the result of the formula, and comparing the result to a threshold for Icon status.

### RELATED APPLICATIONS

This application claims the benefit of U.S. Provisional Patent Application Ser. No. 60/619,989, filed Oct. 19, 2004, which application is incorporated by reference herein in its entirety.

### FIELD OF THE INVENTION

This invention is in the field of computer software and systems, particularly business application software and systems, and particularly such software and systems for the design and marketing of consumer products.

### BACKGROUND OF THE INVENTION

In the marketing of consumer products, there is a significant risk of any given product becoming regarded as a commodity. Once a product is regarded as a commodity, consumers tend to make purchase decisions between competing products solely on price. At this point, it becomes difficult to continue to manufacture the product profitably. This phenomenon occurs even with products that are sophisticated from the standpoint of such features as technology, design and materials. While there are many examples, the consumer electronics area, particularly home audio systems, is one area where technologically complex products have tended to become commodities,

A variety of techniques are employed to differentiate products, so that the products are no longer regarded as commodities. One such technique is establishing a strong brand entity for product or family of products. Branded products in many categories command a premium, as a brand can convey differentiation to the consumer.

One technique to avoid commoditization is the use of celebrity endorsements for a product. However, such endorsements appear to sophisticated consumers to have little meaning other than an exchange of money for the celebrity's name and sponsorship. Some products are marketed with the claim that a celebrity has participated in some way in the design of the product. However, the features selected may bear little connection to the public understanding of the celebrity, and thus prove disappointing to the consumer.

### SUMMARY OF THE INVENTION

In one aspect, a method of the invention described herein is a computer-implemented process of identifying, including a process of arithmetic weighting, individuals who qualify for the status of Icon or Legend in a field. In the method, both objective and subjective factors are considered. Objective factors may be given a greater weight than subjective factors.

Another aspect of the invention is a computer-implemented process for the at least one of the design and marketing of products, in which at least the product or its marketing is associated with an identified Icon. Preferences of the Icon are captured and stored in memory in accordance with at least one systematic survey. The Icon is closely involved throughout the development of the product or marketing tools, such as an environment for sales, promotion and/or demonstration of products, and associated spaces. At least some of the preferences are integrated into the design of the product and/or marketing tools, and the product and/or marketing tools are strongly associated with the identity of the Icon. The design is stored in memory. Marketing tools may include spaces that include and reflect the captured preferences of the Icon, in which one or more products (whether designed in accordance with the method or not), are marketed, demonstrated, discussed, and/or sold. The marketing of the consumer products associates the identity of the Icon with at least one of the consumer products and the marketing venue and communicates to the prospective customer the incorporation of the tastes and preferences of the Icon in the consumer product and/or the marketing space. Captured preferences of the Icon may be reflected in one or both of the design and selection of the consumer products. The marketing may include demonstrations in various venues of the capture and reproduction of the tastes and preferences of the Icon. Examples of spaces and their use may include a recreation of a musical artist Icon's studio to demonstrate consumer products that include sound reproduction equipment and a recreation of a chef Icon's kitchen to demonstrate products that include kitchen appliances and equipment, and resulting food products.

Examples of fields of Icons include authors and poets, fashion designers, motion picture actors and directors, live theater actors and directors, television actors and directors, industrial design such as the design of automobiles and home furnishings, ergonomic design, architecture, interior design, furniture design, artists such as painters and sculptors, furniture designers, woodworkers and carpenters. Many other examples may be contemplated within the scope of the invention.

### BRIEF DESCRIPTION OF THE FIGURES

FIG. 1 is a schematic diagram of a computer system in accordance with an embodiment of the invention.

FIGS. 2A and 2B constitute a flow diagram of a high-level process flow of a method in accordance with an embodiment of the invention.

FIGS. 3A, 3B, 3C and 3D constitute a process flow diagram relating to a method for the design and marketing of a consumer product in accordance with an embodiment of the invention.

### DETAILED DESCRIPTION OF EXEMPLARY EMBODIMENTS

Implementations of the present invention include methods for the design and development of products and for the design and development of space associated with marketing of the product. The process of design should be understood to include all aspects of the product and the space, including the selection of the product category, the selection of functional features of a product, the selection of features affecting the appearance of the product, the selection of a space, the shape of the space, the physical appearance of the space and of furniture and objects within the space, and the clothing, choreography and scripting of personnel staffing the space. An advantage of this method is the creation of a new marketing platform to invoke desire and stimulate demand of an extraordinary brand across a population, which may be the mainstream population or a subset thereof.

Icons in any industry have, and are generally recognized both others in the field as well as members of the public familiar with the field, as having an ability to sense and judge what affects the creative process in their fields. Such an ability may be, for example, an ability to judge good sound for those in the music field, to judge a superior visual experience for those in the motion picture field, to judge superior ingredients, equipment, techniques and dishes for those in the culinary arts. There are many other examples of such abilities in these fields. This ability to judge reflects both conscious and subconscious judgments, which may have been shaped by any number of experiences and influences in the life of the Icon. In the method, a collaborative process identifies these judgments, which may also be described as tastes and preferences, and through a collaborative process, identifies and tests designs to achieve designs of products, selection of products, and/or marketing of same to obtain reproductions of the judgments, preferences and tastes.

The inventor has appreciated that, in many fields, based on their contributions to the advancement of the field and the shaping of tastes in the field, individuals who have attained a high level of respect from both the public and their peers, are in a far better position to influence and to contribute to the properties and/or selection of products and to the marketing of same, than are design professionals, such as electronic, electrical, mechanical and industrial engineers alone, without the input of such an Icon.

Among other methods, the present invention includes a method of marketing that is designed to stimulate the consumer to learn more about, and ultimately engage with the selected and/or designed products Influenced directly by an Icon as well as optionally building upon the products' existing reputation, the offering's value is enhanced both consciously and sub-consciously by associating the products and/or their marketing to the Icon's national or international reputation. As such, the products capitalize on the mass appeal, trust, and fame and influence that the consumers perceive the Icon him or herself possesses.

Although the present application fully describes what constitutes and thus defines an Icon, other labels may be substituted or used to mean the same, such a Living Legend, Celebrity, Star, Superstar, Idol, Personality, A Famous Person, Renown, Hero, Luminary and Notable.

It is important to appreciate that the invention described herein does not merely use the Icon as an endorsement; rather the Icon is involved, depending on the specific implementation, in many facets of the selection, development and design of the consumer product, the brand, and the marketing and/or demonstration thereof. In the prior art, when celebrities are used in the endorsement of a product, their purpose, of course, is to help differentiate and thus promote the product to the end consumer for sale for service. Accordingly, we call this endorsement process an “Indirect-Based Relationship”. Where as, in this invention, the Icon operates in an “Entirety-Based Relationship”, by providing his or her raw intellectual input on many areas of the design and selection process for the products and marketing spaces, as well as by capturing his or her preferences and tastes for reproduction in the products and/or in the electronics for acoustic treatment of the Icon's home or other listening areas.

It is to be understood that the figures and descriptions of the present invention have been simplified to illustrate elements that are relevant for a clear understanding of the present invention, while eliminating, for the purpose of clarity, many other elements found in typical computer systems, software architecture, and computer methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein

The present invention is operable with computer storage products or computer readable media that contain program code for causing a processor to perform the various computer-implemented operations. The computer-readable medium is any data storage device that can store data which can thereafter be read by a computer system such as a microprocessor. The media and program code may be those specially designed and constructed for the purposes of the present invention, or they may be of the kind well known to those of ordinary skill in the computer software arts. Examples of computer-readable media include, but are not limited to magnetic media such as hard disks, floppy disks, and magnetic tape; optical media such as CD-ROM disks; magneto-optical media; and specially configured hardware devices such as application-specific integrated circuits (ASICs), programmable logic devices (PLDs), and ROM and RAM devices. Examples of program code include both machine code, as produced, for example, by a compiler, or files containing higher-level code that may be executed using an interpreter. Steps in the computer-implemented methods may be implemented in processors running software stored locally, and/or in configurations such as application service providers, in which certain steps are executed on processors communicating with one another over a network such as the Internet. Either stand-alone computers or client/server systems, or any combination thereof, may be employed.

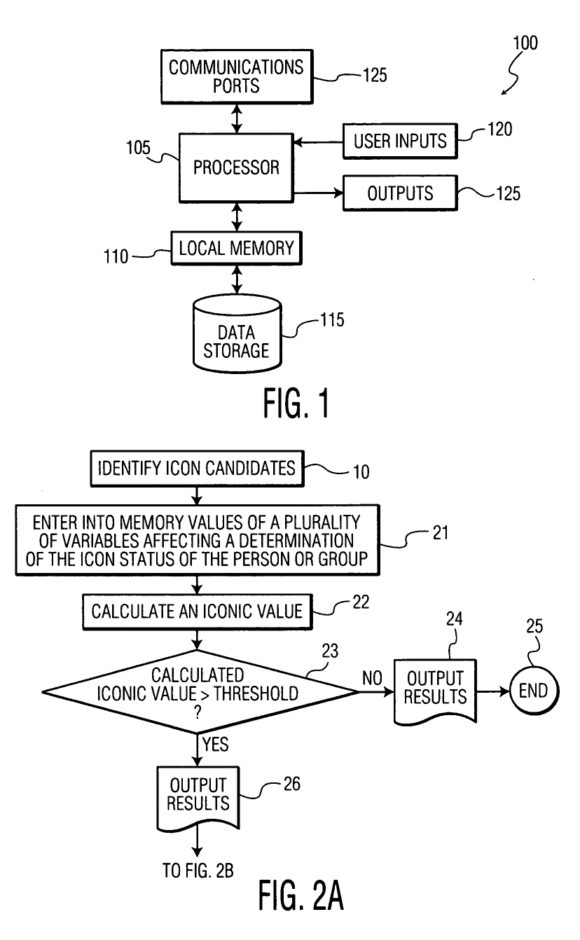

The methods of the invention may be carried out by an exemplary computer system of the type illustrated in FIG. 1. Referring to FIG. 1, an exemplary computer system 100 is schematically illustrated in simplified form. Exemplary computer system 100 has processor 105, which executes instructions contained in programs. Local memory 110 is configured to exchange data with processor 105, and may store programs containing processor-executable instructions, and values of variables for use by such programs. Mass storage 115 may include a wide variety of data acquired and processed in accordance with the invention, organized, for example, in one or more relational databases. User input may be provided at inputs 120, which may include keyboards, mice and touchscreens. Outputs 125 may include displays as well as printers. Communication port 130 may connect to any suitable network or device, including without limitation a local area network and/or the Internet. Any data acquired may be manually input, scanned, acquired from another data source, and then entered into memory. Various steps of the method may be accomplished by the processor under control of one or more programs stored in memory.

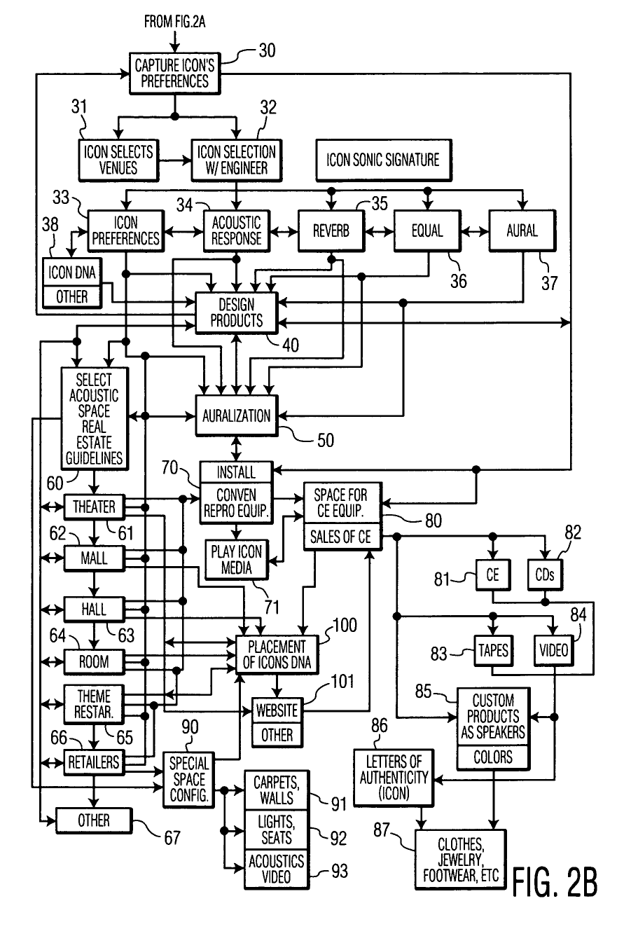

Referring to FIG. 2, a system-level flowchart illustrating an exemplary process flow in accordance with an embodiment of the invention is shown. Referring to FIG. 2, a process flow may commence with a step of identifying a candidate Icon, as illustrated at block 10. Values of variables affecting a determination of the Icon status of the person or group are provided to memory, as indicated at block 21. A weighted system calculates, based on an algorithm reflecting weighting of the variables, an Iconic value of the person or group, as indicated at block 22. The calculated Iconic value is then compared to a threshold Iconic value, as indicated at block 23. If the calculated Iconic value is less than a threshold value, then a determination has been made that the individual or group does not hold Iconic status. The result is output, and then the process ends, as indicated at blocks 24 and 25. If the calculated Icon value is at least the Iconic value, then a determination has been made that the person or group holds Iconic status. The result is output at 26, and the process flow continues.

The process flow continues to capturing of the Icon's preferences, as indicated generally at block 30. In this step, preferences of the Icon are captured, and are stored in memory. At least some of the preferences are captured in a systematic manner, such as by using a paper or computerized survey form.

The process flow may include proceed to the step of Icon evaluation of selection of a venue, indicated at block 31. The selection of the venue may be based on an existing venue with which the Icon is familiar. By way of example, the selected venue may be a home studio of an Icon in the field of music, a home or restaurant kitchen of an Icon in the field of culinary arts, a home studio of an Icon in the field of motion pictures, a home workshop of an Icon in the field of woodworking, furniture making or carpentry. In that event, the selected venue may be visited, and characteristics, defined in a systematic manner, recorded in memory. Alternatively, a systematic method, such as a printed or interactive survey form or tool may be provided for the Icon to select characteristics and features of a venue.

The process flow also includes, in this illustrative example, following the step of capturing the Icon's preferences, the step of systematically obtaining with an Icon the characteristics of a space, as shown at block 32. This process selection may include incorporation of the previously recorded and stored preferences. The previously stored Icon preferences may be incorporated, as indicated at block 33. For an Icon in the field of music, properties of the venue that may be systematically recorded include acoustic response, as indicated at block 34, reverb, as indicated at block 35, equalization, as indicated at block 36, and auralization, as indicated at block 37. For an Icon in the field of culinary arts, properties may include the precise location, dimensions and identity of available kitchen equipment, inventorying ingredients, and recording lighting and sound. For an Icon in the field of woodworking, furniture making or carpentry, the properties to be recorded may include the position, dimensions and identities of equipment, workbenches, tools and supplies, by way of example. At least one of these properties is recorded, and two or more of these properties may be recorded. Any recorded property is duly recorded in memory.

In the example illustrated, as indicated at block 40, the product design provides a product that incorporates the Icon's systematically captured preferences. It will be appreciated that rather than or in addition to product design, this step may include product selection. For example, a musical Icon may select recordings and existing sound reproduction equipment for sale in a space that is closely identified with the Icon. In the case of sound reproduction equipment, the systematically captured preferences include the preferences found in the selected venue. The preferences may also include a wide variety of features of a product, as described in greater detail below.

From the step of product design or selection, the next category of activities is the marketing of the designed or selected consumer products. The marketing of the designed consumer products both associates the Icon with the consumer products and communicates to prospective customers the incorporation of the preferences of the Icon in the consumer products.

The designed physical space may be used to market, demonstrate and/or sell designed and/or selected products. The designed physical space reflects the captured preferences of the Icon, and provides a strong association between the Icon and the space. An appropriate venue is selected according to guidelines for selection of real estate. Such guidelines may specify, for example, types of facilities, demographic characteristics of the surrounding area, types of nearby business, and other factors.

In the following example, an exemplary implementation will be explained with reference to an Icon in the field of music. However, it will be appreciated that the same principles may be applied with respect to Icons in other fields.

A musical Icon may be used to directly and indirectly promote the designed products through and at concerts: At each venue in which the Icon will tour, various forms of product placement and sonic auditioning may take place. In many large venues such as a stadium, there are typically Skyboxes or other enclosed boxes, which are typically used by VIP's or for business entertaining. These areas would be able to support the inclusion of a set of CE products for which an Icon has an entirety-relationship role with a company. As the public views the live concert, so can CE product be viewed, thereby invoking a bond with the audience. The products may also be auditioned in this environment. The Icon may use this venue to inform and educate his or her general audience at large about the brand of the designed products and the products themselves, and its (their) availability. The Icon may wear apparel which carries the name of the product or Brand either in a fancifully form or in a written form. The general audience may be able to hear a recreation of the CE products acoustic properties through the sound system being used at the stadium. The Icon may show a video of his or her home, and accompany the video with a soundtrack of the artist writing and playing the particular soundtrack in his or her home. The end result would provide the general audience with a sensation that the video they are seeing was actually captured in the Icon's home and not at a studio. It would enhance the overall credibility of the video while being able to portray the Icon's actual use of the CE products.

This aspect of the method of the invention may similarly be implemented, by way of example, by having an Icon in the field of culinary arts perform, by demonstrating and explaining various cooking techniques and recipes, in a physical space using designed or selected products, and optionally providing similar spaces equipped with the designed or selected products to permit selected consumers to participate along with the Icon.

Returning to the example of a musical Icon, referring to block 61, one venue may be a theater, and more particularly a theater in which motion pictures and other audiovisual works are typically shown or performed. Such a theater includes a large screen on which the visual portion of the audiovisual work is displayed, and a system of sound emitting devices, such as various speakers, which provide the audio portion of the audiovisual work. In this embodiment, the steps of communicating may include performing a main audiovisual work which includes a creative work of the Icon, and performing an advertising audiovisual work communicating the incorporation of the preferences of the Icon in the consumer product. The main audiovisual work may be a feature motion picture, for example, and the creative work of the Icon may be an acting or musical performance in the motion picture or the soundtrack thereof, and/or the performance of a composition of the Icon in the soundtrack, by way of example. There may be incorporated, either in the motion picture or other main visual work itself, or in a separate advertising segment provided to be played in conjunction with the main motion picture (e.g., a trailer to be shown before the main motion picture), information regarding the consumer product and information associated with the Icon, and particularly the recorded voice and/or image of the Icon using and/or describing and/or promoting the product may be included. Motion pictures may be provided either in analog or digital format, and such theaters are typically equipped with a multi-channel audio playback system. The demographics of the audience for a specific motion picture are typically well defined. Accordingly, advertising and promotion to an audience for a specific motion picture is well suited to reach very specific audience demographics. The motion picture being played in the theater may be accompanied by a musical score or soundtrack. In many instances, the soundtrack includes one or more performances by and/or compositions by the Icon. Similarly, a soundtrack or score may be developed by or with the participation of the Icon. As explained in greater detail above, another aspect of the invention utilizes advanced digital signal processing (DSP) fields, in conjunction with unique Head Related Transfer Functions (HRTF), which characterize the acoustic space of the Icon's listening environment. The result is the production of sound fields to emulate and introduce acoustic spaces, which influence the listeners to perceive and thus interpret that they are experiencing an environment other than that of the movie theater. For example, in a motion picture, the audience is viewing and listening to the artist Eric Clapton on stage (and recorded) at Albert Hall. With prior art reproduction equipment containing Digital Signal Processing (DSP), the audience would sense the creation of some listening area larger then the theater, yet the audience knows that the sonic enhancement is crude and does not accurately depict the attributes of Albert Hall or other venues which may approximate the size and acoustical personality of Albert Hall.

Movie theaters may also be appropriate venues for marketing of consumer products, and particularly consumer products featuring sound reproduction, as walls, floors and ceilings of movie theaters may be made of or covered with materials or coatings selected for good sound absorption. In this process described in this application, utilizing, for example the specific technologies known as Auralization, the actual attributes or personality of the room or other venue in which the recording was originally executed can be faithfully captured. As such, the final recorded product when played back using DSP hardware and convolution software reproduces the music, voice and other acoustical content and the surroundings in which it was recorded in a more realistic presentation. In this example, the acoustical presence of Albert Hall would be fused together with Mr. Clapton's music, to create a highly-accurate recreation of the original performance, including the acoustical attributes of the venue of the performance.

As such, a movie theater is an excellent venue for illustrating and appreciating the invention's advanced acoustical technological capabilities.

It will be appreciated that in production of a main motion picture and an advertising audiovisual work, the production of the audiovisual work should include recording the soundtrack with binaural recording or other HTR recording technologies. Motion picture theaters provided with convolution systems and associated reproduction equipment within the movie theaters' playback infrastructure will be suited to playing the main and advertising audiovisual works.

Various implementations of communicating a connection between the Icon and the designed consumer products may be provided in the context of a motion picture. In one implementation, an advertising audiovisual work, such as a trailer performed prior to a main motion picture, includes the image of the Icon and/or a musical performance by the Icon. Such a trailer may include a recording of the Icon discussing and presenting the designed consumer product, such as a consumer electronics product employed in sound reproduction. The recording may include a discussion, explanation and/or presentation of technology embodied in the designed product. The trailer may include a performance by the Icon of a musical work, such as a musical work which is already known and associated with the Icon, or a new or less well-known musical work, which might be part of the soundtrack of the main motion picture. The trailer may prominently identify the brand of the designed consumer product. The Icon would act as a personality in the trailer; thus, the audience would form a mental connection between the brand and the Icon to create what is known in the field of marketing as “Activation”. Activation is where a predictable response to take action is elicited due to some known marketing stimuli. In this case, the Icon's entirety-based relationship with the designed product engages the consumer to seriously consider the CE products should they or when they will be in the market for audition and subsequent purchase. In one embodiment, in a trailer, one Icon may speak to or illustrate to the audience how the technology works, while some other Icons who are part the brand may present an acoustical illustration of how the above-described consumer products and technology can enhance the rooms personally.

The presentation may include information regarding a retailer or other location or space where the product may be demonstrated and/or purchased, or to websites and other resources for additional information and/or purchase of the consumer product.

In a motion picture theater having installed suitable convolution reproduction equipment, a number of paths of marketing become available. The technology itself may be promoted, without the use of an Icon. In this scenario of marketing, the audience leams of the Auralization technology, which may be branded and promoted in a similar manner to that of the approach Intel has taken: “Intel Inside”. Hence, the audience will firsthand experience the power of the technology in an optimized environment (movie theater) and may seek out this technology when they are ready to purchase a CE solution. In another approach, the CE Brand will be the dominate focus of the advertising message, hence when an audience member is ready to seek to make a purchase of CE product utilizing Auralization technology, they will be predisposed to seek the CE brand seen and heard at the theater.

In another embodiment of the invention, a physical space where the connection between the Icon and the product is communicated to potential consumers is a portion of an enclosed shopping mall, as indicated at block 62. In such an enclosed shopping mall, sound reproduction equipment may be provided which provides for reproduction of a recorded performance by an Icon, or a recorded verbal presentation by an Icon. One or more visual displays may be provided to furnish a visual portion of a performance or presentation.

In another embodiment of the invention, a physical space where the connection between the Icon and the product is communicated to potential consumers is a hall, such as a portion of a convention center or hotel meeting room or ballroom. In such a hall, sound reproduction equipment may be provided which provides for reproduction of a recorded performance by an Icon, and/or a recorded verbal presentation by an Icon. One or more visual displays may be provided in the hall to furnish a visual portion of a recorded performance or presentation. Sound absorbing fabrics and materials may be provided on walls, on stands placed in front of walls, on room dividers, and on other rigid, portable supports, to enhance and control the sonic experience for an audience. Visual materials reflecting the captured preferences of the Icon may be included in the hall for purposes of such a presentation. Similarly, the physical space where the connection between the Icon and the product is communicated to potential consumers may be a room, as indicated at block 64, which may be more or less permanently adapted for such presentations.

In another embodiment of the invention, the physical space where the connection between the Icon and the product is communicated to potential consumers may be a restaurant, as indicated by block 65. The name of the restaurant may reflect a connection with the Icon, such as through use of the Icon's name, nickname, or title of a song or song lyric with which the Icon is closely associated. The decor, furniture, menu and staff clothing of the restaurant may reflect the captured preferences of the Icon. The restaurant space may include sound reproduction equipment which provides for reproduction of recorded performance by an Icon, and/or a recorded verbal presentation by an Icon relating to one or more designed consumer products. One or more visual displays may be provided in the hall to furnish a visual portion of recorded performances and/or presentations relating to one or more designed consumer products. Memorabilia and photographs connected with the Icon may be provided in the restaurant. Sound absorbing fabrics and materials may be provided on walls, on stands placed in front of walls, on room dividers, and on other surfaces, to enhance and control the sonic experience for restaurant patrons.

Any physical space used for marketing may use various artists' personal belongings, the use of the Icon's own, or licensed and/or approved apparel, instruments, photographs, memorabilia, records, tapes, CDs, and other personal items, and physical reproductions of same. Any form of such items which is or may be associated in the public mind with the Icon may be employed, whether items actually used or made by the Icon, or items approved or licensed by the Icon. Such items may serve as physical reinforcements to help the customer better appreciate the Icon's personality and how that has manifested in the designed consumer product's design. Such items may reflect the Icon's childhood, early life, early career, the geographic area or ethnic group where the Icon grew up, interests, and other items. Associating the Icon's childhood, younger days, education, other interests and entrance in to the Icon's field of endeavor establishes the background elements which helps validate the Icon's ability to contribute to the development of the designed consumer product. These physical assets may also be assembled and organized for audition and sale.

In another embodiment of the invention, the physical space where the connection between the Icon and the product is communicated to potential consumers may be within, connected to (as by a passageway) or adjacent to, a physical store location where consumer products of the same general class as the designed consumer product are also sold, as indicated by block 66. For example, if the designed consumer products are electronic sound reproduction equipment, a physical store location where electronic sound reproduction equipment is sold would be of the same general class. The physical space may also be within a physical store location which has traffic that is demographically desirable for marketing of the designed consumer products, regardless of the nature of the products sold at the physical store location.

Any physical space where the connection between the Icon and the product is communicated to potential consumers may have special configurations, as indicated generally by block 90, and in particular may be configured to be suited for demonstrating setup and configuration of the designed consumer product. For example, the space within, connected to or adjacent to a physical store location where consumer products of the same general class as the designed consumer product are sold may include configurations, equipment and materials designed for providing an appropriate sonic experience. The space may be configured as a theater having a raised stage or open performance area and a seating area having attached or portable seats facing the stage or open performance area.

The space may be substantially sound isolated from neighboring spaces. Such sound isolation may be accomplished, for example, by providing the walls, indicated generally at block 91, of any such space with acoustical treatments and sound-absorbing materials sandwiched within the interior and exterior walls, which mitigates the external environmental sound from entering into the space. Entrances, exits and other openings may be fitted with doors with may have one or more of acoustical treatments, sound absorbing materials and tight fits to surround door frames to assist in sound isolation. Fabrics, coatings and materials on or making up the interior walls of the space may be employed to reduce sound reflections greater than 30 milliseconds. It will be appreciated that sound reflections greater than about 30 milliseconds in duration greatly affect the ambience of any listening area. Sound-absorbing carpet may be employed to help mitigate any standing acoustical waves. Lighting is preferably also controlled, as indicated at block 92. A performance may be provided, during which, for example, entrances of the space are closed, and lighting is reduced in the seating area, to focus the attention of the audience on the stage or other performance area. Examples of the consumer products, and particularly sound control and reproduction equipment, are installed, as indicated generally at block 70. Examples of the consumer products may be provided in the stage area, and may be supported and moved by movable platforms, hidden wires, or other techniques, during the performance. Automated, computer-controlled machinery may control the movement and operation of exemplary products and associated lighting through a performance. The exemplary products may appear, be given emphasis by lighting, or are hidden or de-emphasized by the removal of lighting, for different portions of the presentation. Thus, one or more of movement of the consumer products, movement, adjustment and selective activation of lighting, and movement of other staging, such as opaque movable barriers, and/or activation of selectively opaque glass, may be used to cause particular items to appear or disappear. Any suitable theatrical techniques may be employed. Pre-recorded audio tracks may be activated under computer control and coordinated with other elements. The consumer electronics being moved and displayed may be the elements that are actively delivering signals, images and sound. The performance may be highly choreographed to control every aspect of a performance, or may be partially under the control of a human operator. Hence lighting, movement, sound and video may all be all controlled by a processor, and/or an operator interface may be provided to provide control.

The content of the performance is identified with the Icon, as indicated generally at block 71. The content may be narrative, songs, music, video, still photos, artwork and other material. The content and the movement and lighting of the consumer products are preferably coordinated so as to both resonate to elicit a relationship between the Icon and the audience and establish a relationship in the minds of the audience between the Icon and the consumer products. The audience receives the benefit of a visceral experience akin to a well-executed Broadway show. The control over the lighting and sound permits the audience to receive a complete experience of images and sounds, which both communicate the capabilities of the consumer products and the connection between the Icon and the products. This created environment blends the CE Product's capabilities together with the Icon's contribution to the overall experience. The net result evokes a totally enveloping experience of the specific genre couple with the individual Icon(s) that constitute that genre. The Icon is threaded throughout the presentation; videos, photos, voice and music are used to create a fabric of impressions for the customer.

Demonstrations may be provided in this or another environment. For example, as part of the demonstration in the selected space, the CE product can auto-calibrate itself for the room it is placed in. As such, if a room contains many acoustical barriers, and placement of the speakers are not conducive to the aesthetics of the listening location, the system will attempt to electronically correct and thus simulate the optimum product placement location. Additionally, once this is achieved, the system may auto calibrate for frequency response, decay and delay.

A “Sweet Spot” is defined here as an optimum location in a physical space for receiving a sensory experience, including by way of example listening to music and viewing audiovisual works. A Sweet Spot in listening to music, is ordinarily a small area at which virtual cones emanating from each speaker intersect. A variable Sweet Spot follows the individual as the individual moves within a space. Such a system may be demonstrated. The variable Sweet Spot, which, follows the listener in the room and creates a new Sweet Spot. Hence, the spot, at any moment, where the consumer is located is considered the “optimum” position for the sensory experience. In sound reproduction technology, the use of phase correction and volume alterations provides part of the solution.

Consumers may be afforded an opportunity to purchase the designed products immediately either at the physical space, in an adjacent, connected or other store, as indicated by block 81, or may be given information needed for a physical store location, a website or other electronically available location, or a telephone mail order store number.

The invention contemplates a device that may be located in the specific room along with the equipment or may be located elsewhere. This device is a CPU containing a storage device, an Internet port, a software system capable of extremely quick database searches and an ability to write to a variety of media such as Blue Ray Discs, Zip, CD and DVD. When the consumer has completed the sale of his or her CE product or when the user wishes to download music from his or her favorite artists or others, the device is designed to act as a portal that can direct and connect the user directly to all songs available from an artist. This system is also capable of delivering content, which has not yet arrived on the shelves of the retailer. In the same way that certain songs are created to act as Promos specifically for the radio audience, our invention contemplates relating to specific content. Yet another permutation of the invention is to allow users the opportunity to both upload and/or download their room persona or unique parameters to be shared with other users. This approach incorporates concepts from what marketers call an Organic Marketing Platform, such that the users collectively share and build a database of room personalities, constantly updated by the users and which add to the overall value of the CE brand. In short order, the database may have thousands of sound parameters all being developed by the end users themselves and available for sharing with other users. The local device is only an exemplary source for sharing this data; alternatively the data is offered on-line as well. Another function of the local device is to serve as a centralized community allowing for individuals who are interested in other users, who all have an affinity for a particular Icon, group of Icons, or genre of music, in contacting them to communicate with one another. This approach will create greater affiliations to the Icon directly and to members in the community who share the same passion. Its design is to improve sales of the Icon's contents (Music, video, photos, lyrics, narrations) and accessories, and update current users system with enhanced and new releases of products and services.

As indicated by blocks 82, 83 and 84, recorded products on various media may be available in association with the space. Such products may be available at the space, or customers may be provided information to reach a physical store location, website or other electronically available location, or a telephone mail order store number. These products may include recorded musical performances by the Icon or featuring the Icon's compositions, on various media, including compact disc, MP3 or other digital formats, magnetic tape and vinyl records, and audiovisual works on various media, such as videotapes, digital video disks, next generation storage media according to standards such as Blue-Ray. The recorded products may also include information regarding the designed consumer products.

The method may include providing an association or connection between the Icon and a potential customer for or purchaser of the consumer products, including after a purchase of the consumer products, as well as making available content featuring the Icon providing information regarding the Icon's association with the consumer product. In one embodiment, noted at block 101, a website may feature the Icon personally, via any technology available for communication over the Internet (or other two-way communication network, such as interactive television networks) introducing the product(s), providing an overview and giving his or her own story of how and why he or she is involved in the product and any associated brand. The Icon may provide details on the design process and his or her involvement, including any contributions he or she has made to the design. The website may show photos or make available video of his or her favorite listening areas or venue in which the detailed sonic preferences of the Icon were captured. The website may make available recorded presentations that explain and/or demonstrate how the Icon's personal contribution is infiltrated in to various portions or features of the product(s), the marketing, the branding, the PR, and/or the music. Such recorded presentations may be available for download through such tools as QuickTime or other downloadable videos. The site may also offer for sale other items of interest to the viewer such as clothing, other products which reflect the Icon's captured preferences and/or other creative works which the Icon has created or in the creation of which the Icon has contributed. Such creative works may include paintings, sculptures, and photography, by way of example.

A website or other interactive communication network may also be provided further to enhance the sense of a relationship or connection between the customer and the Icon by permitting communication among customers related to the consumer product. For example, information related to consumer products may be uploaded for review and comment by the Icon and other customers. By way of example, the particular arrangement and adjustment of sound reproduction components used by a customer may be posted for review, comment, download and use by others. In effect, the web site provides for a channel to further enhance the relationship between the viewer/fan and the Icon. Furthermore, the web site becomes a tool for consumers to offer their feedback on product upgrades, embellishments, and to offer in their input to future products.

In another aspect of the invention, the method of marketing may include directly and/or indirectly offering a platform from which a customer may select, design and/or purchase off-the-shelf or customized consumer products associated with the Icon. An e-commerce website or other retail store available through two-way communication may be available to customers. A physical retail store may also provide capabilities for a customer to design products and submit the product design to a live salesperson or through an interactive kiosk. An array of customizable features may be available, which can be ordered. Examples of features which may be available include: customizations of a space, Multi Room expansion capabilities, Hard Disc storage space, preloaded music database, Speaker selection, Speaker materials and colors, Customizable front panels, UI software macros, Case colors, Dials colors, Controls colors. The features available may be limited so that all features reflect captured preferences of the Icon.

The Icon may personally execute a Letter of Authenticity (LOA), which is sent to the user and specifically identifies the purchased product, as indicated at block 86. Customized communications other than written documents may be employed to provide this personal communication, such as a personal sound recording or personal mark or signature on a product itself. This customized communication or LOA may also be accompanied with other tangible products associated with the Icon, including by way of example a personalized, signed item, such as a photo of the Icon, a copy of a photograph or other work of art of the Icon, or a recorded performance of the Icon, on media such as CD and or DVD. Other items of interest may also be provided with or without charge, preferably including items or privileges associated with the Icon and not otherwise generally available in the market, which could include products and clothing reflecting the Icon's preferences, premium tickets and VIP passes to performances by the Icon, and clothing. Items may also items not available elsewhere, such as concerts limited to owners of the CE brand product, and recordings and video available only to such owners. Concerts might be made available for download into the configured systems of the consumers, effectively rendering these concerts available only to the purchasers. These services and items may be made available only to purchasers of the consumer product, and/or selectively based on purchases and other interactions, as an acknowledgement of the loyalty of the purchaser or user. This is a process that will enable the CE brand to carry premium positioning in the market and inure all the benefits which come with that position.

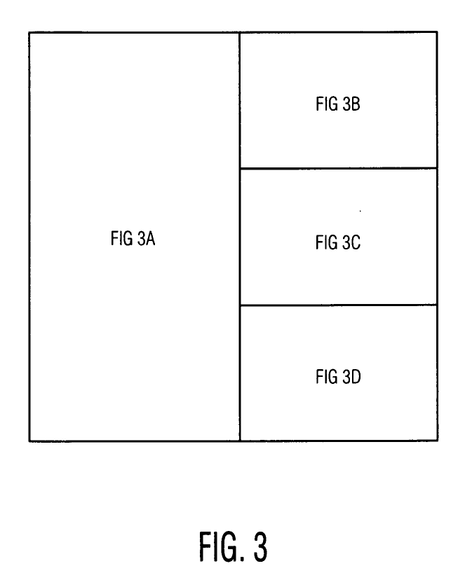

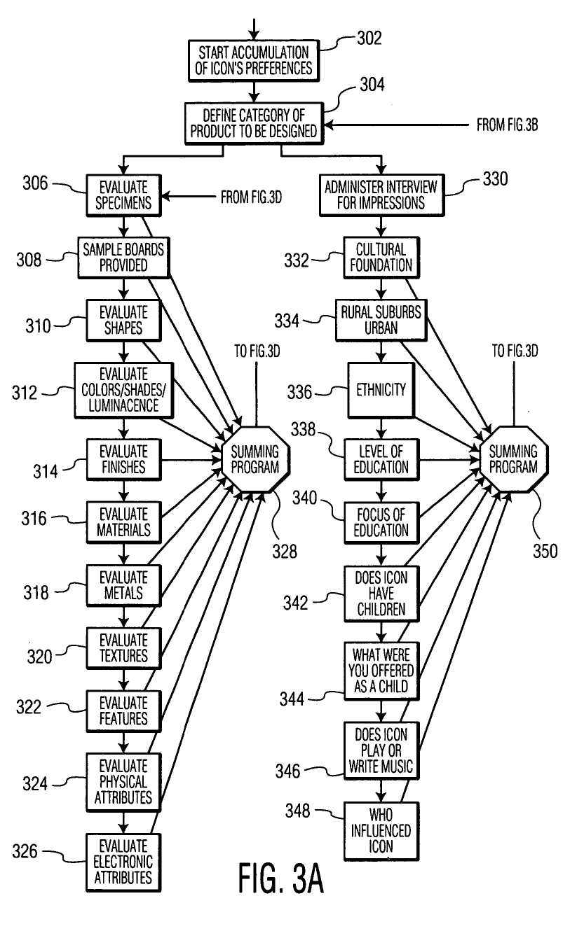

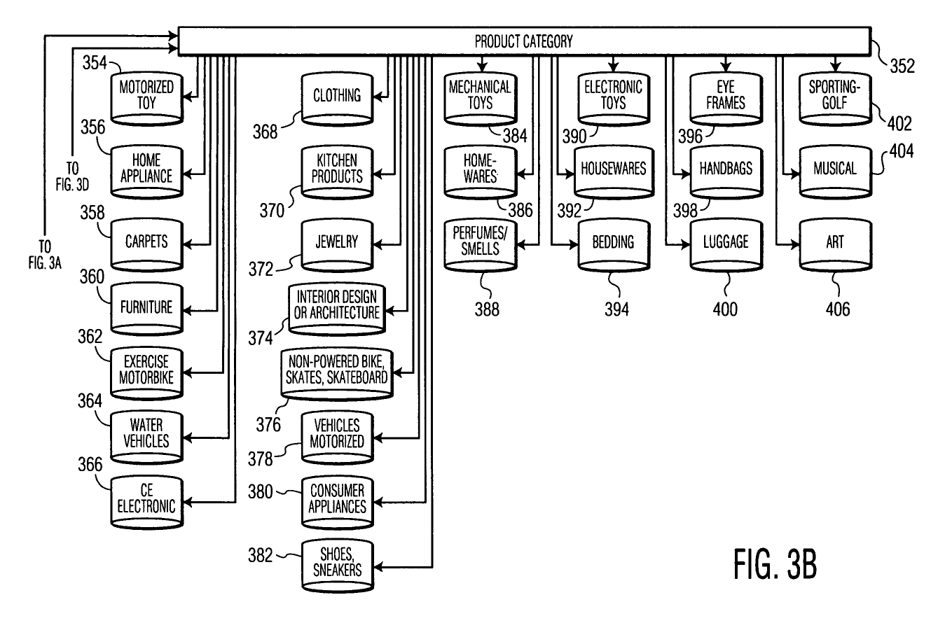

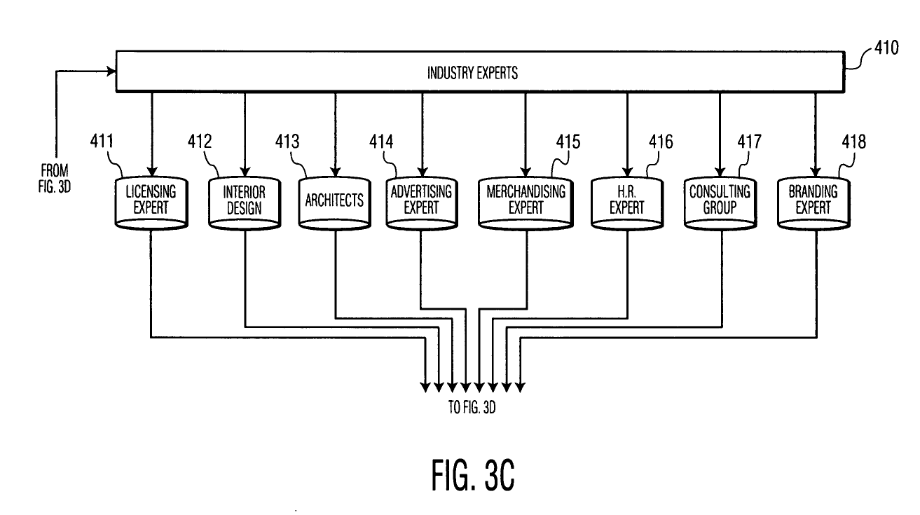

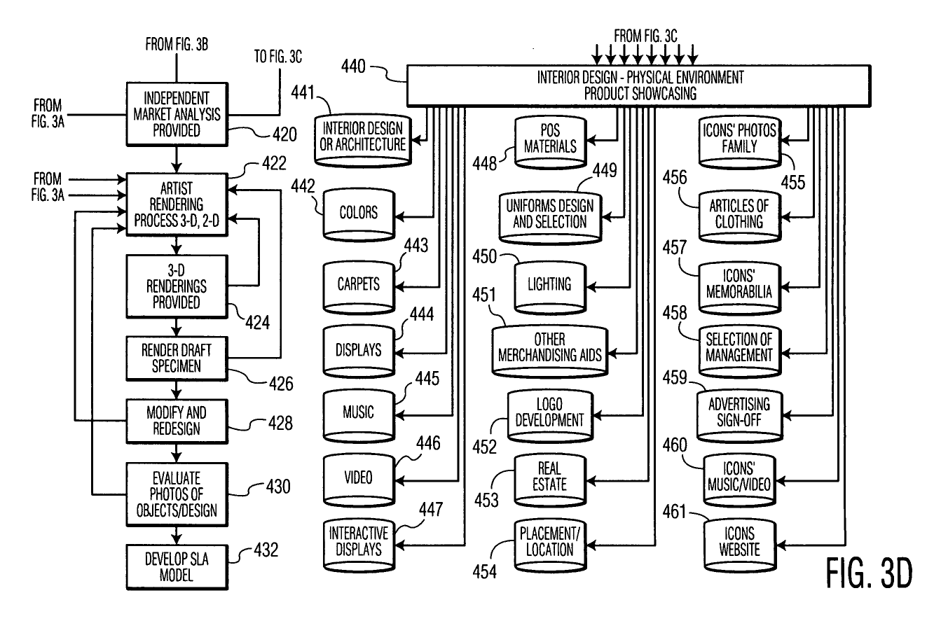

Referring now to FIG. 3A, an embodiment of a method of capturing the Icon's preferences will now be described in greater detail. The step of capturing the Icon's preferences, illustrated as a single block as block 30 in FIG. 2, now commences with a step of starting accumulation of the Icon's preferences, at block 302. This step may be performed with various respect to various categories of products, and may include assessing the Icon's level of interest in various categories and features of products, for example. The flow then proceeds to a definition of the category of the product to be designed, as indicated at block 304. Information as to categories of products, discussed in greater detail in FIG. 3B, may be employed in this step of definition of product category. The defined product category is stored in memory.

After definition of a category of product, two different process flows may be undertaken in any order. As indicated in the column beginning with block 306, one process flow relates to obtaining the Icon's preferences by presenting the Icon with various examples and specimens related to the defined product category. The Icon may be provided with specimens of existing products in the same product category. The Icon provides comments, which are received and then stored in memory.

The method describe permits one to take advantage of the imagination, talent and skills of Icons to create and/or appreciate works of aesthetic value in a variety of fields. These artistic and aesthetic qualities often manifest in the areas of conceptual design, fashion, sculpture, graphics, painting and industrial design. The science behind the cognitive process has been dubbed “Fluxus,” which connotes the blending of different artistic disciplines. As such, the Icon may also contribute ideas on various aspects of products. By way of example, with respect to sound reproduction equipment, such ideas may relate to the product(s) physical shape, features, speaker development, sonic reproduction, sound capturing through digital processing, source material, acoustical palette, product display, product marketing, product exposure and future product enhancement.

Sample boards, with small samples of various materials may be provided to the Icon, as indicated in block 308. Comments from the Icon are recorded and stored in memory. Possible shapes of products are presented to the Icon, evaluated, and commented upon, as indicated in block 310. The Icon's comments are received and stored in memory.

Various qualities related to surface color, including color, shades, and luminescent effects, are presented to the Icon, as indicated in block 312. Comments are provided by the Icon, received and stored in memory. As indicated at block 314, a variety of material finishes are provided to the Icon. The Icon evaluates these, and provides comments, which are received and stored in memory.

Various examples of materials for use in the designed consumer products are presented to the Icon, as indicated in block 316. Comments are provided by the Icon, received and stored in memory.

Various examples of metals that may be used in the designed consumer products are presented to the Icon, as indicated in block 318. Comments are provided by the Icon, received and stored in memory.

Various examples of textures of surfaces that may be used in the designed consumer products are presented to the Icon, as indicated in block 320. Comments are provided by the Icon, received and stored in memory.

Various examples of functional features that may be used in the designed consumer products are presented to the Icon, as indicated in block 324. The functional features may include user interface design, for example. Comments are provided by the Icon, received and stored in memory.

Various examples of physical attributes of the designed consumer products, including such attributes as weight and physical size, are presented to the Icon, as indicated in block 324. Comments are provided by the Icon, received and stored in memory.

Various examples of electronic attributes, including, for consumer electronics, various features related to sound reproduction, that may be used in the designed consumer products are presented to the Icon, as indicated in block 326. Comments are provided by the Icon, received and stored in memory.

It will be appreciated that the foregoing features and attributes are exemplary, and that more, fewer or other attributes may be presented to the Icon in accordance with various implementations of the invention.

All of the Icon's comments are provided to summing program 328, which may include algorithms for ranking and evaluating the various

A further step, which may be conducted before, after and/or simultaneously with the step of obtaining the Icon's comments, is the step of posing questions to the Icon, receiving responses and storing the responses in memory, indicated generally at block 330. The questions may be posed in a face-to-face interview, with an interviewer working from a paper or electronic questionnaire, orally posing questions and recording responses, in a paper questionnaire presented to the Icon, or in an electronic survey form, which may be, by way of example, web-based. This step of posing questions may be directed to obtaining information relating to the life, background and cultural influences of the Icon. The information obtained from this interview step may be employed in the consumer product design process. The information received from this interview step may indicate the cultural influences of the Icon, which may be reflected in the Icon's work and in the image of the Icon held by the public. By way of example, the responses to the specimens provided to the Icon may be affected by the Icon's later life, including changes in tastes and exposure to cultural influences resulting from an Icon's lifestyle as developed after obtaining affluence. Thus, the responses to the questions may indicate different design elements for the consumer products.

Questions relating to the cultural foundation of the Icon may be posed; the responses are recorded and stored in memory, as indicated at block 332. Subjects of the cultural foundation may include the cultural influences and interests in the home, neighborhood, schools and the like of the Icon while a child and/or adolescent. Cultural influences may include music, art, literature, oral traditions, and a wide range of topics that are included under the broad heading of culture.

Questions relating to the geographic area where the Icon has lived at various times in his/her life, focusing on whether the geography was rural, suburban or urban, by way of example, may be posed; the responses are recorded and stored in memory, as indicated at block 334.

Questions relating to the ethnicity of the Icon may be posed; the responses are recorded and stored in memory, as indicated at block 336.

Questions related to the level of education of the Icon may be posed; the responses are recorded and stored in memory, as indicated at block 338. These questions may include both formal and informal education.

Questions relating to the focus of the education of the Icon may be posed; the responses are recorded and stored in memory, as indicated at block 340. The focus of education may include the subjects that the Icon was taught in school, studied on his/her own or informally with one or more teachers and mentors. The focus of education may also include determining the level of interest and enthusiasm of the Icon for various subjects, as well as various approaches to education, e.g., classroom vs. experiential education.

Questions relating to the Icon's children, including whether the Icon has children, the ages of the children, and major events in the Icon's life related to the children, may be posed; the responses are recorded and stored in memory, as indicated at block 342.

Questions relating to what material items and what opportunities, information, values and cultural information were offered and given to the Icon as a child may be posed; the responses are recorded and stored in memory, as indicated at block 344.

Questions relating to whether the Icon writes or plays music, which instruments, which genres and the like, may be posed; the responses are recorded and stored in memory, as indicated at block 346. These questions may be relevant to Icons who are not primarily known for their music; however, these questions may also be relevant to Icons known for music, as these questions may indicate genres, influences, instruments and the like that are related in the Icon's background to those for which the Icon is already known.

Questions relating to the persons, whether individuals or groups, that influenced the Icon may be posed; the responses are recorded and stored in memory, as indicated at block 348.

The responses to all of the foregoing are stored in memory and provided to a summing program, which may operate on the responses according to various algorithms, and may provide the results in the form of one or more reports available for use further in the product design process, as discussed below.

Referring now to FIG. 3B, the general topic of product category is shown at block 352, and exemplary product categories for the consumer product are shown. These product categories may be discussed with and proposed to the Icon in defining the product category at block 304. The product categories may also be provided in the market analysis process discussed below with reference to FIG. 3D.

The product categories indicated are motorized toys 354, home appliances 356, carpets 358, furniture 360, exercise bikes and motorbikes 362, water vehicles 364, consumer electronics 366, clothing 368, kitchen products 370, jewelry 372, interior design or architecture 374 (including interior decorative elements, paints and fabrics, by way of example), non-powered bikes, skates and skateboards 376, motorized vehicles 378, consumer appliances 380 (including personal care appliances), footwear 382, including shoes and sneakers, mechanical, non-motorized toys 384, homewares 386, perfumes, fragrances and smells 388, for personal use and/or for home air treatment, electronic toys 390, housewares 392, bedding 394, eyewear 396, handbags 398, luggage 400, sporting goods (including golf items) 402, musical products (e.g., instruments and sheet music) 404, and art 406. It will be appreciated that these are only exemplary categories, and that additional categories may be included for consideration. Similarly, some categories may be omitted from consideration in an implementation of the invention.

The field of the Icon is not necessarily a limitation on the types and nature of the consumer products. For example, an Icon in one industry may have talents which can be effectively employed to design products from another industry. By way of example, an Icon in the field of music may be included in the systematic design of clothing incorporating is or her preferences.

Referring now to FIG. 3D, there is a shown a process flow commencing with an independent market analysis at block 420. In all the steps of this process flow, it will be appreciated that designs, comments and evaluations may be presented to a user, and stored in memory, at each step. The independent market analysis is conducted using the selection of product categories, and may include various conclusions as to the nature of products, possible pricing, possible market segments and distribution channels, by way of example.

The results of the independent market analysis, and the inputs and preferences received from the Icon, are combined in the creation of, indicated at block 422, artist's renderings of the designed consumer products. The artist's renderings may be two-dimensional or three-dimensional, prepared by hand on paper or in modeling clay or similar substance, and/or may be prepared electronically in two or three dimensions in various drawing, CAD and modeling programs. Input for the renderings includes, by way of example, the market analysis results, and the results of the summing programs resulting from the evaluation and interview with the Icon.

Based on at least one set of artist's renderings, the process flow then moves to the step of creating three-dimensional renderings, as indicated at block 424. Such renderings may be created by hand, by way of example. Review of the renderings may result in modification of the prior artist's renderings, and then creation of new three-dimensional renderings, as indicated by the line leading from block 424 to block 422. After three-dimensional renderings are accepted, the next step may be to create draft specimens of the designed consumer products, as indicated at block 426. Upon review of the draft specimens, changes may be made to the artist's renderings, as indicated by the line leading from block 426 to block 422. Upon further review of the draft specimen, the specimen may be modified and redesigned, as indicated at block 428, and new and revised artist's renderings may be created. Following this step, photographs of the modified and redesigned consumer product may be created, as indicated at block 430. The photographs may be evaluated by the Icon and others, and the results of the evaluation are saved to memory. The evaluation may result in comments that prompt revision of the artist's renderings, as indicated by the line extending from block 430 to block 422. Once the photos appear to be acceptable, the process flow continues to development of a stereolithographic apparatus (SLA) model, as indicated at block 432.

Referring now to FIG. 3C, a step of consultation by various experts will now be discussed, indicated generally at block 410. Exemplary industry experts are identified below, and may include (a) licensing experts 411, who provide advice on licensing of rights in the Icon's name and other aspects of the Icon's persona on various products and services; (b) interior design experts 412, who may provide advice and services on the furnishings and appearance of the space at least; (c) architects 413, who provide advice and services on the architectural components of the space; (d) advertising experts 414, who may provide any type of services offered by advertising agencies, including by way of example advice on marketing and advertising strategies for the advertising of the consumer products; (e) merchandising experts 415, who may provide advice on product design and manufacturing issues, for example; (f) human resources experts 416, who may provide advice on selection and management of sales personnel; (g) a consulting group 417, who may provide advice and services related to miscellaneous issues, and (h) a branding expert, who may provide advice and services related to the selection and promotion of one or more brands, including word mark(s), logos, and the integration of the brand into the marketing. All of the foregoing experts may be given the benefit of the results of the evaluation and the interview of the Icon, to assist with consistent embodiment of the image and essence of the Icon into the space, the merchandise, the advertising, the people, and the brand, as well as other aspects and features of the product. All of the input of these experts is preferably stored in memory, for example in one or more database programs.

The input of the foregoing experts is provided in connection with the design of the space, and related issues, as indicated generally in FIG. 3D at 440, and in more detail below. Aspects and features of the marketing of the consumer product that may be reviewed include by way of example: interior design or architecture of the space 441; colors of the products and of the space 442; carpets in the space 443; displays 443 used in the space or elsewhere for the consumer products, mock-ups of same, or other materials; music 445 for use in the space and to be used in connection with marketing and advertising of the consumer products; video 446 to be performed in the space and to be included in other advertising and promotion; interactive displays 447 for incorporation in the space for demonstrating capabilities and features of the products; point of sale materials 448 for inclusion at the space and at retailers; design and selection of uniforms 449 and/or detailed clothing guidelines for sales and promotional personnel; the design and implementation of lighting 450 for the space, including the incorporation of computer-guided lighting in the performances; other merchandising aids 451, including by way of example giveaway items to serve as reminders of the designed products and their association with the Icon; the development of a logo 452, and related word mark, together with consistency with the products and the Icon's image; real estate selection and acquisition 453 for the space; and placement and location 454 of the space in relation to neighboring establishments or to a retail store in which the space is contained. Additional items for use in connection with the marketing of the product, which may be selected may include various items from the Icon's life, such as the Icon's photographs 455, including the Icon, the Icon's family, friends, early appearances, and the like; articles of clothing 456 worn by the Icon; and other Icon's memorabilia 457. Other steps that the indicated experts may assist with include selection of management for one or more enterprises that will carry out the steps of the method and provide ancillary services 458, final approval and sign-off of advertising 459, production and selection of the Icon's music and video to be associated with the advertising, and the creation and operation of a website 461 for the Icon.

The process of identification of an Icon will now be discussed in greater detail. It will be understood that the preceding method may be carried out using an individual or group who has achieved Icon status, without the systematic identification of an Icon. Candidate Icons may be identified in any field. Exemplary fields include musical performance, musical composition, fashion design, interior design, furniture design, architecture, restaurants and cooking, broadcasting, film (including acting, directing and other disciplines), carpentry, and others. The weighted system preferably places a greater weight on objective factors than on subjective factors. Each of these factors may be normalized and assigned a particular weight in a formula. Examples of objective factors include measurable commercial success. Commercial success may be measured by a variety of tools, including sales of products associated with the candidate Icon. For those in the music industry, sales of recorded and sheet music, numbers of performances and gross revenues, would be objective factors. For those in fashion design, sales of designed clothing would be a factor. For those in the field of interior design, revenue for design services would be factor. For those in the furniture design field, revenue of sales for designed furniture would serve as an objective factor. For those in the field of restaurants and cooking, objective factors such as number of restaurants owned and operated, revenue at such restaurants, numbers of cookbooks sold, and numbers of television shows broadcast.

Subjective factors include generally factors that reflect a decision by one or more critics or arbiters as to the status of the individual or group. For those in all industries, favorable critical commentary and numbers of appearances with a photograph in various publications are examples of subjective factors. Admission to honorary societies, such as, for musicians, the Rock and Roll Hall of Fame, is another type of subjective factor. It will be appreciated that a variety of objective and subjective factors may be developed in any field, considering both the importance of the factors, and the availability of information.

In Table 1, using the example of a candidate Icon in the musical field, various data points are set forth, together with their rank in importance in the weighting scheme, from 5 at the highest to 1 at the lowest, a proposed definition, a definition, and exemplary factors and sources of data specific to the musical field.

TABLE 1

| Data Points | RANK | Definition | Examples |
|---|---|---|---|
| 1. commercial | 5 | Substantial revenue | 1a) album or singles sales in excess of |
| success | | generated from a | 100,000 units of a given release as |
| | | combination of music | measured by Soundscan data |
| | | sales, live performance | 1b) number of RIAA (Recording Industry |
| | | and radio airplay. | Association of America) gold, platinum and |
| | | | diamond certifications for sales of |
| | | | albums/singles* |
| | | | 1c) number of Top 10 albums/singles on |
| | | | Billboard charts* |
| | | | 1d) number of No. 1 albums/singles on |
| | | | Billboard charts* |
| | | | 1e) placings within the Top 50 on Pollstar's |
| | | | yearly ranking of concert income |
| | | | 1f) point value as expressed on Joel |
| | | | Whitburn's Top 600 Artists ranking for |
| | | | albums and singles* |
| | | | *data readily available by consulting Joel |
| | | | Whitburn's Top Pop Albums, 1955-2001, |
| | | | Top Pop Singles, 1955-2002 and annual |
| | | | update volumes |
| 2. work remains | 5 | Artist's | a) album placings on Billboard catalog sales chart @ |
| relevant over time | | recordings/compositions | b) “most played” rankings on MediaBase.com/BDS |
| | | remain commercially | c) number of films (biopic/documentary) or television programs |
| | | viable in the | made about artist* |
| | | marketplace after | d) number of books written about artist # |
| | | period of initial impact, | e) number of re-recordings of artist's songs by other artists ˆ |
| | | and continued media | f) combined SoundScan weekly sales (all of artist's recordings) |
| | | visibility is also | of over 5000 units |
| | | maintained. | g) continued presence within the Top 100 on Pollstar's yearly |
| | | | ranking of concert income |
| | | | @ data available via billboard.com (membership required) |
| | | | *imdb.com or allmovie.com |
| | | | # bookfinder.com or amazon.com |
| | | | ˆ song search via allmusic.com |
| 3. Effective use of | 5 | Artist has an impact | 3a) number of appearances in feature films* |
| movies/TV/videos | | on public | 3b) number of appearances on television programs # |
| | | consciousness | 3c) number of compositions and/or recordings used on motion |
| | | through effective use | picture/TV soundtracks # |
| | | of visual media | 3d) number of MediaBase.com spins of music videos |
| | | | 3e) number of appearances on Billboard/MTV/VH-1 music video |
| | | | airplay charts % |
| | | | 3f) number of appearances on Billboard music video sales |
| | | | charts % |
| | | | *imdb.com, Leonard Maltin's Movie Guide |
| | | | # imdb.com |
| | | | % billboard.com |
| 4. “Crosses over” | 4 | Artist's work appeals | 4a) Number [if greater than 2] of different Billboard genre |
| to unite divergent | | to devotees of | charts (e.g. pop, country, jazz, R & B, dance, rock, hip-hop) |
| audiences | | multiple genres. | artist has appeared on during career* |
| | | | *Billboard.com & various Joel Whitburn (recordresearch.com) |
| | | | chart books |
| 5. Life story | 4 | Artist is perceived in | 5a) Number of Lexis/Nexis hits produced by a search for |
| acquires mythic | | public consciousness | [artist's name] and any of the following terms: “legend,” |
| dimensions | | as towering figure | “legendary,” “mythic,” “larger-than-life” (terms should be |
| | | who is legendary, | located within 5 words of artist's name) |
| | | larger-than-life, etc. | |
| 6. Strong work | 4 | Artist consistently | 6a) number of different decades in which artist has appeared |
| ethic | | records and performs | on Billboard Hot 100 albums or pop singles charts |
| | | publicly over an | 6b) number of times artist has charted 5 or more albums |
| | | extended period of | (Billboard) in any given decade |
| | | time. | 6c) number of concert and television appearances over 100 in |
| | | | any given decade* |
| | | | *Pollstar, imdb.com |
| 7. Musical | 3 | Artist introduces new | 7a) Number of Lexis/Nexis hits produced by a search for |
| innovation | | ideas and concepts | [artist's name] and any of the following terms: “pioneer” |
| | | into the pop | “pioneering,” “innovative,” “innovator,” “innovation” (terms |
| | | mainstream. | should be located within 5 words of artist's name) |
| 8. Personal | 3 | Artist's career | 8a) inducted into Rock & Roll Hall Of Fame? (1 = yes, 0 = no) |
| stature increases | | accomplishments are | 8b) recipient of Lifetime Achievement Grammy award? (1 = yes, |
| over time | | recognized with | 0 = no) |
| | | “lifetime | 8c) recipient of Billboard Century Award? (1 = yes, 0 = no) |
| | | achievement”-type | 8d) recipient of Kennedy Center Honors? (1 = yes, 0 = no) |
| | | awards. | |
| 9. Critical | 3 | Artist's work is hailed | 9a) number of 4-star and 5-star album ratings in The Rolling |
| acclaim/consistent | | by recognized critical | Stone Album Guide (fourth edition, 2004) |
| quality of work | | authorities. | 9b) number of 4-star and 5-star album ratings in The Rolling |
| | | | Stone Album Guide (third edition, 1992) |
| | | | 9c) number of 4-star and 5-star album ratings in The Rolling |
| | | | Stone Record Guide (second edition, 1983) |
| | | | 9d) number of 4-star and 5-star album ratings in The Rolling |
| | | | Stone Album Guide (first edition, 1979) |
| | | | 9e) number of albums rated A-minus, A or A-plus on |
| | | | robertchristgau.com |
| | | | 9f) number of 4-star and 5-star album ratings on allmusic.com |
| | | | 9g) number of 4-star and 5-star album ratings in The Virgin |
| | | | Encyclopedia Of Popular Music |
| | | | 9h) number of albums rated 8, 9 or 10 in The Great Rock |
| | | | Discography |
| | | | 9i) number of album placings in the Top 40 positions in the |
| | | | annual Village Voice Pazz & Jop Critics' Poll |
| 10. Strong visual | 2 | Artist's visual image | 10a) Number of hits from a Corbis photo archive search* |
| identity | | is expressed/defined | *http://pro.corbis.com/search/searchFrame.asp (set max. |
| | | via large quantities of | number of hits in “view options” to 10,000.) |
| | | photographic imagery | |
| | | (as seen in books, | |
| | | magazines, | |
| | | newspapers, etc.) | |
| 11. Live | 2 | Artist expands | 11a) Number of live albums and commercially released concert |
| performance skills | | audience and | videos released by artist* |
| | | reputation via live | *allmusic.com |
| | | performance. | |
| 12. Physical | 2 | Artist possesses an | 12a) Number of Lexis/Nexis hits produced by a search for |
| appearance/sex | | appealing physical | [artist's name] and any of the following terms: “sexy,” “hot,” |
| appeal | | appearance. | “attractive,” “handsome,” “beautiful,” “cute,” “pretty,” |
| | | | “gorgeous” (terms should be located within 5 words of artist's |
| | | | name) |
| 13. Premature | 1 | Premature death | 13a) artist did not die of natural causes (1 = yes, 0 = no) |
| death | | heightens the artist's | |
| | | mystique/mythology | |
| 14. Recognizable | 1 | Artist is so well- | 14a) artist is recognizable by first name only (1 = yes, 0 = no) |
| by first name only | | known that only a | |
| | | first name is sufficient | |
| | | to identify them in | |
| | | public consciousness. | |

It will be understood and appreciated that one of ordinary skill in the art, seeking to design a formula for assessing the Icon status of a musical artist or group, may generate one or more suitable algorithms using the data above which assign numerical values. By ranking the musical artists using such an algorithm, a threshold may be determined which separates those who have achieved Icon status from others. Similarly, one of ordinary skill in the art may use many of the same data points and rankings, while using different factors and sources of data, for potential Icons in other fields. While in some embodiments of the invention, a single icon status may be provided, various degrees of Icon status may also be provided at various defined thresholds. It will also be appreciated that the fourteen data points above may be altered within the scope of the invention, and that the sources of information may be changed. As to the sources of data, sampling of information available through books, subscription services, and database inquiry are variously used. The sources may include information from the broadcast and cable networks, television stations, national syndicates, regional cable television systems, satellite providers, advertisers and advertising agencies, as well as radio station play lists, including RAM technology.

In the example of determining whether professionals in the motion picture field, including, for example, actors and directors, exemplary variables for determining whether a motion picture actor is an Icon might include:
A. Number of Movies Made
B. Gross Revenue of Movies Made
C. Number of Purchased Tickets by consumers to see movie while in theater
D. Number of Videos sold of movies when released on home video
E. Number of National News Stories
F. Number of National TV appearances

It will be appreciated that items A-D are relatively objective and therefore entitled to a greater weight in a weighted formula, while items E and F reflect the subjective judgments of editors and television producers, and are thus entitled to a lesser weight. Possible sources of information for these factors may include:

Academy of Motion Picture Arts and Sciences: http://www.oscars.org. The Academy of Motion Picture Arts and Sciences, which annually presents the Oscar Awards for outstanding achievements in filmmaking, provides a searchable database of past Oscar winners. Also available is the Index to Motion Picture Credits (IMPC), a searchable database listing motion picture credits from all films released in Los Angeles County each year. Rather than listing every person credited on a film, emphasis is placed on those crafts that the Academy honors at awards time. These include credits from the producing, directing, art directing, cinematography, visual and special effects, costume design, film editing, sound and sound editing, makeup and hairstylists, music, writing and acting fields. Song titles that appear in the database are those submitted by their composers for awards consideration. In addition to personal credits, IMPC also collects information on production and releasing companies, MPM ratings, running times, Los Angeles release dates, color, language, source authors and source material. The complete IMPC database covers the years from 1976 to the present. Selected data are available going back to 1934.

American Film Institute: http://www.afi.com. The American Film Institute, dedicated to advancing and preserving the art of the moving image, provides the AFI Catalog of Feature Films, a database containing filmographic information for films produced from 1893-1950 and 1961-1970. Details on cast, crew, plot summaries, subjects, genres, and historical notes are included for each film. The database contains over 25,000 entries for silent American films from the years 1893 to 1930. Entries for approximately 750 silent feature films also include information on availability and sources for VHS tapes, laserdiscs and DVDs.

Baseline: http://baseline.hollywood.com. Baseline.Hollywood.com describes itself as “the entertainment industry's premiere resource for film and television information, featuring over 1.5 million database records on projects tracked from development to release, cast and crew credits, box office grosses, celebrity biographies, talent contact information, company directories, and industry news; all easily searchable online and updated daily.”

Exhibitor Relations Co. http://www.exhibitorelations.com/ The oldest full service film industry statistical research firm, Exhibitor Relations Co. provides services to the film industry, news media, and anyone interested in movies and box office data. Since 1974, it has provided schedule information, grosses, film statistics, production notes, and custom research information. It also provides information on feature release dates and films in production.

Motion Picture Association of America. http://www.mpaa.org The Motion Picture Association of America, which assigns content ratings to motion pictures and television programs, provides a searchable movie ratings database for all rated films.

National Film Preservation Board: http://www.loc.gov/film. The National Film Preservation Board of the Library of Congress selects up to 25 “culturally, historically or aesthetically significant films” each year for the National Film Registry. A complete list of selected films is available on the NFPB web site.

Variety: http://www.variety.com. Variety, the news magazine of the entertainment industry, provides data on domestic box office receipts (from March 1994 to date), international box office receipts (March 1997 to date), and film and television production charts (January 1998 to date).

One example of this process is the creation of a line of consumer electronic (CE) products, which are intended to obtain unusually high market acceptance, preferably fueled by radical applications of technology, distributive ergonomic design, and positioning through music artists who have achieved the status of Icons. In the example of the music industry, the design and development process results in the design of consumer electronic products having a superior level of acoustical reproduction, enhanced functionality, overall physical styling and associated attributes which are segmented by various musical genres. This unique advancement (which includes but is not limited to collaboration, technology, and marketing) and associated design process utilizes the contributions of various music experts, all of whom are well recognized by the general listening community as Icons in their field for achieving an Iconic level of public presence and regard. These individuals possess a gift, in part constituted by an authoritative prospective on what comprises “good sound.” Each expert maintains his or her own internal conscious, by which he or she subconsciously measured all other music. Each expert also has a profound body of knowledge, or expertise, regarding the genre he or she performs in, as well as the music industry as a whole. By incorporating such personal expressions into the CE product(s), products are developed that reproduce in various environments, a unique set of parameters for the reproduction of music that are unique to the individual Icon. In an example below, the sound qualities of the home studio of a music Icon are captured in the design and development of the consumer product. These acoustical preferences will be translated and replayed at the end users listening environment, delivering an acoustical representation of the Icon's own listening environment and palate of sonic taste. The Icon's “ear” is in essence lent to the consumer through the installation and configuration in the consumer's space of CE product(s). Other preferences of Icons in other fields may be captured. Examples might include the attributes of the home theater of an Iconic film director; the electronics of the workspace of an Iconic computer hardware or software developer or executive; the office of an Iconic business executive; the studio of an Iconic visual artist; the woodshop of a master carpenter or other craftsman; the home or office, or portion of same, of an Iconic architect; the office or other writing area of an Iconic author. It will be appreciated that the sonic qualities, music selections, and other qualities, apart from the field of expertise of these individuals, may be systematically measured and applied to the design of consumer products. The consumer electronics design process described herein incorporates a multifaceted approach. By first gaining specific knowledge and direction from the Icon(s), this process anchors and ultimately shapes the overall persona (personality) of the end product which will be found in the home of the buying public.

In this exemplary method, Icons in the musical field, as well as those in other fields who are recreating a studio environment, “lend their ears” to the process. This process is quite technical and is fully disclosed in my copending U.S. patent application Ser. No. 11/179,817, filed Jul. 12, 2005, which application is incorporated herein by reference in its entirety. In essence, samples of the Icon's music, or other music as appropriate, are played and then optimized by the Icon in the Icon's own preferred physical environment. The optimized data is coupled or “tagged” to the original song. Using this data, in the configuration of the product, at the consumer's residence, or other selected location, the tag is then added to the acoustical reproduction process using specialized hardware and auralization software. The result is the faithful reproduction of musical content as if it were being listened to in the Icon's listening room, having the Icon influence the sonic qualities he or she believes are ideal.

Working in conjunction with an acoustical engineer, the Icon develops a listing of rooms and venues, which he or she considers ideal listening environments. The Icon is provided with a recording instrument, preferably a binaural recording head such as the Neumann KU100 Microphone System Dummy Head, Sennheiser MKE2002, KEMAR Dummy Head, Schoeps KFM6 Binaural Microphone, ESLAB “Sphere” Binaural Microphone or the Core Sound Binaural Microphone. The desired/chosen transducer will sit it front of the Icon as he or she advance through the process of capturing the Impulse Response Characteristics of the listening environment. After this has been archived, the Icon then auditions a number of tracks which may be on different media, such as MP3, CD, Vinyl, Tape, etc. These tracks are assembled from a collection of music that the Icon has contributed to or has been debuted over the Icon's career or other music. The Icon is provided with a personal digital assist (PDA) or other user interface, which allows him or her to control various properties of the sound emanating from each loudspeaker in the system. These controls would include multiple bands of equalization (such as ⅓ octave, parametric, shelving or other equalization techniques), The palates controls range from 32 bands of equalization, up to 100 ms of decay, reverberation, auralization or other sound processing. The end result of the process is to accurately capture the Icon's own Psychoacoustics (as described below) interpretation of the particular listening environment(s). This information becomes integrated in to the electronic reproduction equipment (playback system) in such a way that the end users don't “hear” the room acoustics that they are in, rather they hear the program material in a way that substantially reflects the, but more so the acoustical properties of the Icon's listening room.

As any sonic experience is subjective, principles of psychoacoustics are preferably applied. Humans can perceive where sounds come from—above, below, behind, to the side. This is called spatial localization. In particular, the stereophonic ears of humans can discern azimuth or horizontal (left-right) directionality, and zenith or vertical (up-down) directionality. Humans perceive directionality using localization cues such as Interaural Time Difference (ITD), Interaural Intensity Difference (IID), and pinna filtering. The Interaural Time Difference (ITD) is the difference in arrival time of a sound at each eardrum. Because ears of humans are separated by about six inches, sounds coming from the left or right will arrive at the corresponding eardrum first. Although the delay time differences are slight, the brain can extract precise directional information from this data.

The head, as well as shoulders and upper torso, form a barrier to a sound's arrival at one ear or the other. This creates an acoustical shadow and an effect called the Interaural Intensity Difference (IID). For example, a sound coming from the extreme left has a lowered intensity in the right ear (in addition to an ITD time delay). The lowered intensity is due in part to the added distance (sound amplitude decreases over distance) to the right ear, but also from the acoustical shadow cast by the body itself. Each ear thus receives slightly different amplitudes from sounds that are not directly equidistant to the two ears. The effect of the shadow is frequency dependent; high frequency sounds are more attenuated than low frequency sounds because low frequencies (those with wavelengths larger than the width of the head) can bend around obstructions and are not as easily blocked. For this reason, for example, the high frequency information in a complex waveform is more readily perceived at the incident ear—this relative difference in timbre is yet another cue used to determine directionality.

The outer ear provides still more information on a sound's directionality. Sound enters the ear canal through direct paths, and indirect paths that reflect from the complex folds of the pinna. When the reflections of the indirect sounds combine in the ear with the direct sounds, pinna filtering occurs, changing the received sound's frequency response. The ear/brain duo interprets this equalization, producing cues (assisting zenith localization, for example) from the filtering effect. To provide still more directional cues, small head movements allow the ear/brain to judge relative differences in the soundfield perspective. With this acuity, humans can hear sounds coming from all around, whether they are naturally created or coming from the speakers of a stereo or surround sound system.

In some cases, where true directionality is not available, the ear and brain can be fooled. Cues from ITDs, IDs, and pinna filtering enable us to perceive sound direction. These cues can be combined into one measurement called a Head Related Transfer Function (HRTF). An HRTF defines how a sound's frequency and amplitude responses are altered before entering the ear canal. Using an HRTF, an original sound may be taken, processed with an HRTF, to create a sound that will contain the cues of a sound from a particular direction. The ear/brain will interpret the cues, and judge that the sound's direction is from another point in space. For example, in theory, stereo speakers could create a surround soundfield.

HRTFs are created from ITD, IID and pinna measurements associated with a certain azimuth and zenith (and possibly distance). The HRTF acts as a kind of filter that replicates that particular directionality. HRTF parameters can be measured using either real human heads or dummy heads. Tiny microphones are inserted into the ear canals, and a recording is made of a sound source from many different azimuths and elevations. Each particular measurement represents one sound source direction. HRTFs provide insight into localization cues. For example, inspection of HRTFs for sounds coming directly from the right at different elevations would show the effects of pinna filtering. The notches in the filtered frequency response would change in number and frequency position with different elevations as direct and indirect sounds combine in the ear. This particular data would help reveal how we detect elevation.

In addition, HRTF processing can be used to trick the ear. For example, a sound from a stationary speaker at an arbitrary elevation could be processed by this series of HRTFs. As its frequency response gradually changes, the ear/brain would perceive changing elevation from the stationary source. Similarly, complex surround sound fields can be synthesized from stereo speakers, but the ear/brain is not entirely fooled. The realism of the created soundfield will suffer if the listener, listening to sound from speakers as opposed to headphones, moves from the “sweet spot” between the speakers because the delicate balance of cues will be upset. Moreover, as the folds of each listener's pinna are different; generic HRTFs cannot exactly match our own psychoacoustic expectations. In PC sound cards, using cross-talk cancellation techniques to improve perceived channel separation cleans up the 3D sound image in two channels, but headphones, with their superior real channel separation deliver a better two-channel experience. This type of sound field rendering in two channels is called binaural rendering. The auralization technology described in the above-captioned patent application permits the capture of an individual home studio and then reproduction of the sound qualities of the home studio in another location.

Advantages of the invention include accurate identification of Icons, and building an entirety-based relationship between an Icon and the consumer. In the entirety-based relationship, as many aspects as possible, including appearance, features, functionality, marketing, and ancillary communications, reflect the captured preferences, early influences and tastes of the Icon. This not only is an effective marketing tool for the Brand but also for the Icon. In this manner, the Icon can acquire a presence that is larger than the Icon him or herself.

In addition to the techniques described above, the Icon may be used to directly and indirectly promote the CE products through other media, including print: The Icon may be interviewed, photographed, recorded and filmed using the CE product in his or her listening locations and others. The approach is designed to stimulate the consumer to become activated, and ultimately engage with the available CE products influenced directly from an Icon as well as build upon the CE products existing reputation and credibility by consciously and sub-consciously associating the CE products to the Icon's national or international reputation. Accordingly, the CE products take on the mass appeal, trust, fame and influence that the consumers perceives the Icons themselves have.

In many cases, the Icon will be part of a larger Iconic group, such as being a member of a band, a singing group, an orchestra, trio, duet, etc. Under this situation a number of possible scenarios exist. The group or specific members of the group may collectively contribute to the physical design, user interface process and the recording venues. In another iteration, the group may split off and handle different portions of the design and capturing of the unique sound parameters of a given location. In yet another iteration, the Icon may not be the exclusive member behind the marketing: the marketing may in fact take the form of a number of members of the group or the Icon may be a silent member of the marketing, but contribute to all the design and acoustical capturing components described herein. Any possible combination of the various processes describe above may exist where two or more members function under the aegis of a group (or other).

Genres: The processes described in this application contemplate the segmentation of unique and separate CE products and their respective listening-demo areas defined by musical genre. Currently, the invention contemplates products crafted into one of five genres. For expression purposes only, they have been segmented in to following genres: Rock, Jazz, Urban, Classical, and Country. The invention contemplates that other genres may be added as necessary. Each genre specific demonstration area contains hardware, software, content, electronics, user interface, packaging, accessories and paraphernalia that have been designed with the specific focus on capturing the tangible and intangible essence of a group of Icons which fall in to one of the genres listed. A well-choreographed collection of items will emit and communicate that the CE product belongs to a designated family of products segmented by genre. Each member of the family is specifically designed to capture the environmental, physical, communal and the cultural properties that embody and constitute that specific genre. This approach is analogous in many ways to that of the clothing industry. Clothing is designed and marketed by specific market segments. Clothing, footwear, accessories, makeup, jewelry and the venues or stores themselves offer a specific genre of clothing a unifying impression, which is crafted to envelope the customer into that genre. The clothing industry has many such genres; Vintage, Young Teen, Retro, Punk, Haute Couture, Contemporary, Grunge, Classic, Euro and All American (designer, junior, missy, and contemporary). As consumers peruse the offerings of clothing at any major department store, the entire display and purchasing area is typically choreographed with music, jewelry, cosmetics, lightning, displays, automobiles, sporting goods, colors, materials and surfaces, all which lead the consumer to experience a setting in which the appropriate genre of clothing is orchestrated to offer it optimum presentation.

It will be appreciated that many variations are possible within the scope and spirit of the invention. Without limiting the scope of the invention, such variations include the omission or variation of the process of identifying an Icon, either within the field of music, or to encompass other fields of endeavor; the variation of the lists of preferences and varying of methods and technologies for capturing lists of preferences; varying analysis and processing of preferences and incorporation of preferences into the design and development of products; varying the products themselves; and varying the marketing techniques and venues that tie the Icon's identity and the incorporation of the preferences of the Icon to the consumer product, including varying venues and techniques for demonstrating one or more products.

What is claimed is:

1. A computer-implemented method for at least one of the design and marketing of one or more consumer products associated with an identified Icon, comprising the steps of:
(a) capturing and storing in memory a plurality of preferences of the Icon in accordance with at least one systematic survey of at least some of said preferences; and
(b) creating a design for at least one of a consumer product and an environment for sales, promotion and/or demonstration of at least one consumer product, said design incorporating said captured preferences; and
(c) storing the design in memory.

2. The method of claim 1, further comprising capturing and storing in memory information concerning the background of the Icon.

3. The method of claim 1, further comprising the step of receiving from the Icon a selection of a venue.

4. The method of claim 3, wherein said selection corresponds to an existing venue.

5. The method of claim 3, wherein said selection corresponds to characteristics of a venue.

6. The method of claim 3, wherein at least one of acoustic response, reverb, equalization, and aural properties of the venue are stored in memory.

7. The method of claim 4, wherein said step of designing said consumer product comprises causing said consumer product to reproduce at least one captured property of the existing venue when deployed in a space.

8. The method of claim 1, further comprising the step of marketing of the consumer products, comprising associating the Icon with the consumer products and communicating to prospective customers the incorporation of the preferences of the Icon in the consumer product.

9. The method of claim 8, wherein said step of communicating is performed in a physical space.

10. The method of claim 9, wherein the physical space is a theater for performance of motion pictures.

11. The method of claim 10, wherein said step of communication comprises performing a main audiovisual work comprising a creative work of the Icon, and an advertising audiovisual work communicating the incorporation of the preferences of the Icon in the consumer product.

12. The method of claim 9, wherein said physical space is a shopping mall.

13. The method of claim 9, wherein said physical space is a hall.

14. The method of claim 9, wherein said physical space is a restaurant.

15. The method of claim 9, wherein said physical space is at least one of within, connected to, or adjacent to a physical store location where consumer products of a same class as the designed consumer products are sold.

16. The method of claim 9, wherein said step of communication comprises providing a performance including controlled movement and lighting of the designed consumer product.

17. The method of claim 16, wherein said physical space is sound isolated.

18. The method of claim 8, further comprising the step of providing to a customer for the consumer product an association with the Icon.

19. The method of claim 19, wherein said step of providing an association comprises making available content featuring the Icon providing information regarding the Icon's association with the consumer product.

20. The method of claim 8, further comprising the step of permitting communication among customers related to the consumer product.

21. The method of claim 8, further comprising the step of permitting customers to design and purchase consumer products incorporating preferences of the Icon.

22. The method of claim 1, wherein said step (a) comprises defining a category of product to be designed.

23. The method of claim 22, wherein said step (a) comprises receiving comments from the Icon regarding products in the defined category.

24. The method of claim 23, further comprising the step of, after said step (a), providing samples of elements of the proposed consumer products to the Icon, receiving comments from the Icon, and storing the comments in memory.

25. The method of claim 24, further comprising, after said step of storing the comments in memory, processing the comments in a summing program.

26. The method of claim 1, further comprising the step of posing questions to the Icon, receiving responses and storing the responses in memory.

27. A method of determination of whether a person or group qualifies for Icon status, comprising the steps of:
(a) entering into memory values of a plurality of variables affecting a determination of the Icon status of the person or group;
(b) calculating at at least one processor, based on an algorithm reflecting weighting of the variables, an Iconic value of the person or group;
(c) comparing the calculated Iconic value to a threshold Iconic value, and determining that the person or group qualifies for Icon status if the calculated Iconic value exceeds the threshold Iconic value, and
(d) storing the result of the determination in memory and providing the result of the determination to an operator.

28. The method of claim 27, wherein said variables comprise objective and subjective variables, said objective variables having a greater weighting than said subjective variables.

29. The method of claim 28, wherein said person or group is in one of the fields of music, industrial design, interior design, architecture, ergonomic design, architecture, interior design, furniture design, culinary arts, painting, sculpture, woodworking, motion pictures, television and live theater.

30. The method of claim 29, wherein said objective variables comprise at least numbers of items sold.

31. The method of claim 29, wherein said subjective variables comprise at least comments from critics.

32. A computer-implemented method for acquisition of information for use in connection with at least one of the design and marketing of one or more consumer products, comprising the steps of:
(a) providing questions and items to an Icon;
(b) receiving the Icon's responses to the questions and items, the responses representing a plurality of preferences of the Icon, and recording the preferences in memory.

33. The method of claim 32, wherein the questions comprise questions regarding the Icon's childhood and/or adolescence.

34. The method of claim 32, wherein the items comprise features of one or more consumer products.

35. A method for at least one of the design and marketing of one or more consumer products, comprising the steps of:
(a) creating a design for at least one of a consumer product and an environment for sales, promotion and/or demonstration of at least one consumer product, said design incorporating captured preferences of an Icon; and
(b) storing the design in memory.

36. The method of claim 35, wherein the design comprises functional features of the consumer product.

37. The method of claim 36, wherein the environment comprises a physical space.

38. The method of claim 37, wherein the design comprises providing Icon memorabilia in the physical space.

39. The method of claim 37, wherein the design comprises providing for sale in the physical space consumer products selected by the icon.

40. A method for marketing of a consumer product, comprising the steps of:
(a) communicating to prospective customers incorporation of preferences of an Icon in at least one of the design and/or marketing of the consumer product; and
(b) making the consumer product available for purchase.

41. The method of claim 40, wherein said step of communicating comprises providing a sales environment having a physical design incorporating preferences of the Icon.

42. The method of claim 42, wherein said step of communicating comprises providing a space having personnel wearing apparel in accordance with an approval of the Icon.
